(19) United States
(12) Patent Application Publication
(10) Pub. No.: US 2010/0182964 A1
(43) Pub. Date: Jul. 22, 2010

(54) APPARATUS, METHOD AND COMPUTER PROGRAM MEMORY MEDIUM PROVIDING EFFICIENT SIGNALING OF RACH RESPONSE

(75) Inventors: Jussi Kustaa Ojala, Helsinki (FI); Juha Sakari Korhonen, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/664,950

(22) PCT Filed: Jun. 20, 2008
(86) PCT No.: PCT/IB08/52456

§ 371 Date: Dec. 16, 2009

Related U.S. Application Data
(60) Provisional application No. 60/936,429, filed on Jun. 20, 2007.

(51) Int. Cl. H04W 72/04

(52) U.S. Cl. 370/329

(57) ABSTRACT

Disclosed are various exemplary embodiments of apparatus, methods and memory medium storing computer program instructions for both a base station and a user equipment. For example, an apparatus includes a radio frequency transmitter and a controller configured to derive a resource assignment for a random access channel response for at least one user equipment. At least part of the resource assignment is specified explicitly and at least part of the resource assignment is specified implicitly. The controller is further configured to transmit a message that includes the derived resource assignment for the random access channel response to at least one user equipment.

### TECHNICAL FIELD

The exemplary and non-limiting embodiments of this invention relate generally to wireless communication systems, methods, devices and computer program products and, more specifically, relate to the use of a random access channel between a user equipment and a wireless network access node.

### BACKGROUND

Various abbreviations that appear in the specification and/or in the drawing figures are defined as follows:

3GPP third generation partnership project

UTRAN universal terrestrial radio access network

Node B base station

UE user equipment

HO handover

EUTRAN evolved UTRAN

aGW access gateway

eNB EUTRAN Node B (evolved Node B)

PDCCH physical downlink control channel

PDSCH physical downlink shared channel

RACH random access channel

LTE long term evolution

CDM code division multiplexing

FDD frequency division duplex

FDMA frequency division multiple access

OFDMA orthogonal frequency division multiple access

SC-FDMA single carrier, frequency division multiple access

TTI transmission time interval

UL uplink

DL downlink

BCH broadcast channel

QPSK quadrature phase shift keying

QAM quadrature amplitude modulation

MCS modulation coding scheme

TBS transport block size

CRC cyclic redundancy check

CRNTI cell specific radio network temporary identifier

PRB physical resource block

L1 layer 1 (physical layer)

L2 layer 2 (radio resource control)

RA-RNTI random access radio network temporary identifier

TFI transport format indicator

MAC medium access control

MAC-ID MAC identifier, may be the same as C-RNTI

CW code word

FFS for future study

A proposed communication system known as evolved UTRAN (E-UTRAN, also referred to as UTRAN-LTE or as E-UTRA) is being specified within the 3GPP. In this system the DL access technique will be OFDMA, and the UL access technique will be SC-FDMA.

In some wireless communication systems, such as the LTE (E-UTRAN) system, the UE connects to the network using a RACH. The procedure of initial connection establishment varies between different systems. For example, in the LTE system part of this procedure involves the UE (or several UEs) sending a RACH preamble in pre-defined radio resources, and the eNodeB sending a RACH response. The RACH response is divided into two parts. The signaling of RACH response allocation is done via L1/L2 control signaling, i.e., using the PDCCH, and the eNode-B response is sent in a corresponding PDSCH to one or several UEs.

In general, the resources involved in the L1/L2 control signaling can be considered as scarce resources, and thus any opportunity that arises to reduce the number of signaling bits is important. This is especially true for signaling related to random access, as in this case the eNB does not have accurate information on the channel status of the DL, and therefore is unable to optimize the resources according to signal quality.

### SUMMARY

The foregoing and other problems are overcome, and other advantages are realized, by the use of the exemplary embodiments of this invention.

In a first aspect thereof the exemplary embodiments of this invention provide a method that includes deriving a resource assignment for a random access channel response for at least one user equipment, where at least part of the resource assignment is specified explicitly, and at least part of the resource assignment is specified implicitly; and transmitting a message comprising the derived resource assignment for the random access channel response to at least one user equipment.

In another aspect thereof the exemplary embodiments of this invention provide a memory medium that stores computer program instructions. The execution of the computer program instructions results in operations that comprise deriving a resource assignment for a random access channel response for at least one user equipment, where at least part of the resource assignment is specified explicitly, and at least part of the resource assignment is specified implicitly; and transmitting a message comprising the derived resource assignment for the random access channel response to at least one user equipment.

In another aspect thereof the exemplary embodiments of this invention provide an apparatus that includes a radio frequency transmitter and a controller configured to derive a resource assignment for a random access channel response for at least one user equipment, where at least part of the resource assignment is specified explicitly and at least part of the resource assignment is specified implicitly. The controller is further configured to transmit a message comprising the derived resource assignment for the random access channel response to at least one user equipment.

In another aspect thereof the exemplary embodiments of this invention provide a method that includes receiving a message that comprises a resource assignment for a random access channel response and interpreting the received message, where at least part of the resource assignment is specified explicitly and at least part of the resource assignment is specified implicitly.

In another aspect thereof the exemplary embodiments of this invention provide a memory medium that stores computer program instructions. The execution of the computer program instructions results in operations that include receiving a message that comprises a resource assignment for a random access channel response and interpreting the received message, where at least part of the resource assignment is specified explicitly and at least part of the resource assignment is specified implicitly.

In a further aspect thereof the exemplary embodiments of this invention provide an apparatus that includes a radio frequency receiver and a controller configured to interpret a received message that comprises a resource assignment for a random access channel response, where at least part of the resource assignment is specified explicitly and at least part of the resource assignment is specified implicitly.

In a still further aspect thereof the exemplary embodiments of this invention provide an apparatus having means for deriving a resource assignment for a random access channel response for at least one user equipment, where at least part of the resource assignment is specified explicitly and at least part of the resource assignment is specified implicitly, and means for transmitting a message comprising the derived resource assignment for the random access channel response to at least one user equipment.

In yet another aspect thereof the exemplary embodiments of this invention provide an apparatus having means for receiving a message that comprises a resource assignment for a random access channel response and means for interpreting the received message, where at least part of the resource assignment is specified explicitly and at least part of the resource assignment is specified implicitly.

### BRIEF DESCRIPTION OF THE DRAWINGS

In the attached Drawing Figures:

FIG. 1 shows a simplified block diagram of various electronic devices that are suitable for use in practicing the exemplary embodiments of this invention.

FIG. 2 shows a previously proposed DL signaling entity for the PDCCH.

FIG. 3 shows one non-limiting example of a DL signaling entity for the PDCCH in accordance with the exemplary embodiments of this invention.

FIG. 4 is a logic flow diagram that illustrates a method, and the operation of a computer program product, for a wireless network node in accordance with the exemplary embodiments of this invention.

FIG. 5 is a logic flow diagram that illustrates a method, and the operation of a computer program product, for a user equipment in accordance with the exemplary embodiments of this invention.

### DETAILED DESCRIPTION

By way of introduction, and as was noted above, the resources involved in the L1/L2 control signaling may be considered to be scarce resources, and any opportunity that arises to reduce the number of signaling bits is important. This is especially true for signaling related to the random access since the eNB does not have accurate information on the channel status of the DL and, as a result, cannot optimize the resources according to signal quality.

The inventors have realized that the normal DL signaling entity contains bits that are unnecessary for assigning the RACH response. For example, HARQ is not utilized for the RACH response, thus there is no need to reserve bits for HARQ. Another possibly unnecessary information field contains some number of bits for expressing pre-coding information. In general, pre-coding is of limited value if the eNB has the need to send RACH responses to several UEs in a TTI. Moreover, the inventors have realized that the signaling can be simplified at least for the reason that the format of the RACH message is known. Thus, and although responses to several UEs can be combined in one message, the number of payload bits needed for one, two, three or more combined responses is known a priori.

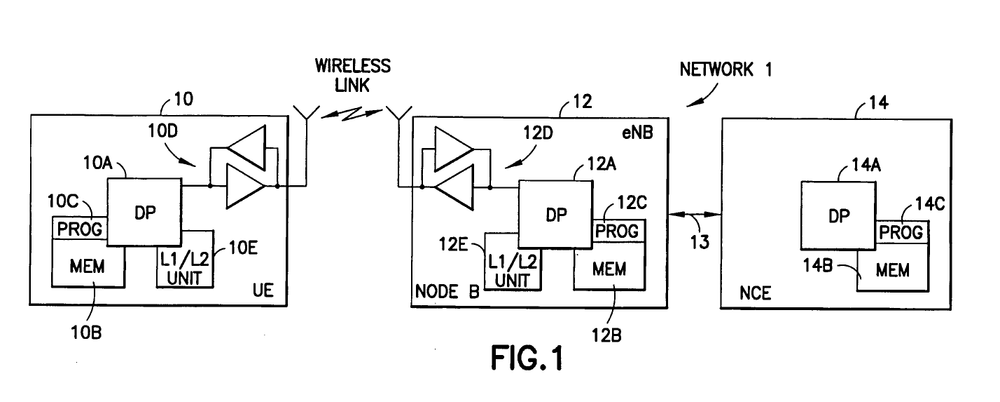

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via a Node B (base station) 12, also referred to herein as an eNB 12. The network 1 may include a network control element (NCE) 14. The UE 10 includes a controller embodied as at least one data processor (DP) 10A, a memory (MEM) 10B (a memory medium) that stores program instructions (PROG) 10C, and a suitable radio frequency (RF) transceiver 10D for bidirectional wireless communications with the Node B 12. The Node B 12 also includes controller, embodied as at least one DP 12A, a MEM 12B (a memory medium) that stores program instructions (PROG) 12C, and a suitable RF transceiver 12D. The Node B 12 is coupled via a data path 13 to the NCE 14 that also includes a DP 14A and a MEM 14B storing an associated PROG 14C. At least one of the PROGs 10C and 12C is assumed to include program instructions that, when executed by the associated DP, enable the electronic device to operate in accordance with the exemplary embodiments of this invention, as will be discussed below in greater detail.

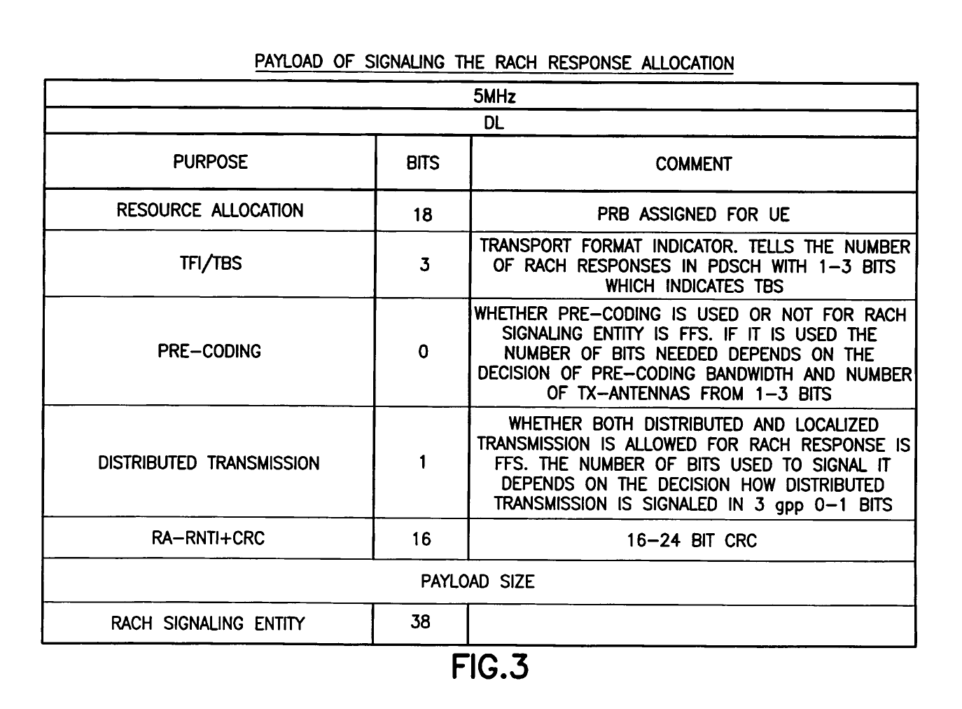

For the ensuing discussion it is assumed that the eNB 12 includes a L1/L2 unit 12E (implemented in hardware or software, or as a combination of hardware and software) that is configured to construct a RACH response message for the UE 10, as discussed in detail below and shown in FIG. 3. The UE 10 is assumed to include a L1/L2 unit 10E (implemented in hardware or software, or as a combination of hardware and software) that is capable of interpreting the received RACH response message, as described below.

Thus, the exemplary embodiments of this invention may be implemented at least in part by computer software executable by the DP 10A of the UE 10 and by the DP 12A of the Node B 12, or by hardware, or by a combination of software and hardware (and firmware).

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B may be of any type suitable to the local technical environment and may be implemented using any suitable data and computer program storage technology, such as semiconductor-based memory devices, flash memory, magnetic memory devices and systems, optical memory devices and systems, fixed memory and removable memory. The DPs 10A, 12A may be of any type suitable to the local technical environment, and may include one or more of general purpose computers, special purpose computers, microprocessors, digital signal processors (DSPs) and processors based on multicore processor architectures, as non-limiting examples.

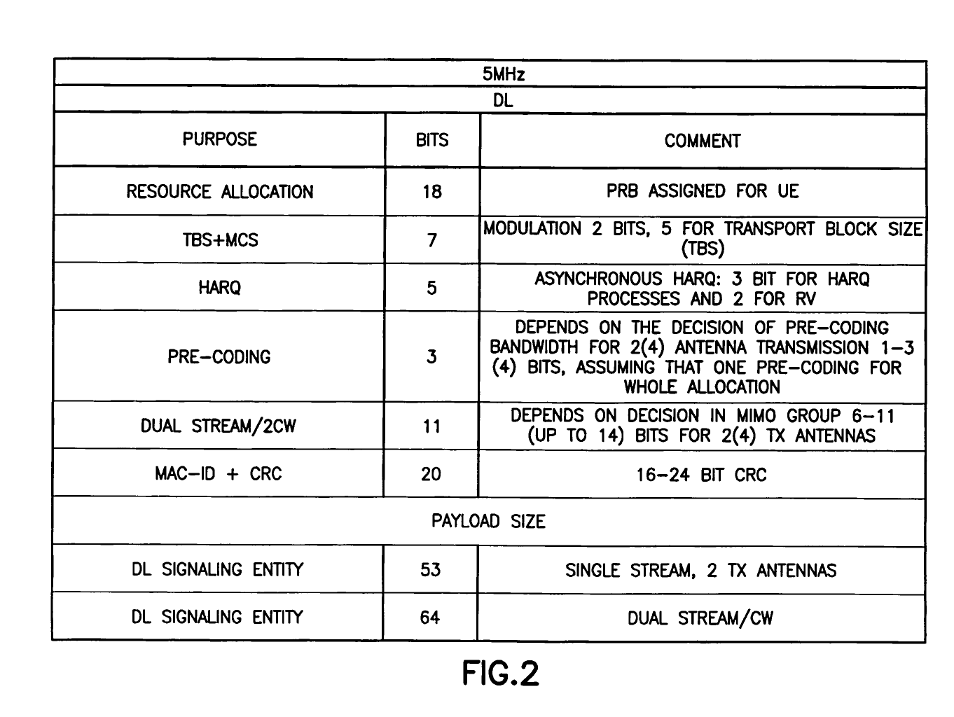

Turning now to the detailed description of the exemplary embodiments of this invention, it should be noted that at least as of the filing of the priority application the payloads of the various signaling entities were not yet defined in 3GPP. One proposal (for a 5 MHZ bandwidth carrier) is found in 3GPP TSG RAN WG1 #49 Meeting, Kobe, Japan, May 7-11, 2007, “PDCCH UL and DL signaling entity payloads”, Nokia, Nokia Siemens Networks, R1-072301, which is incorporated by reference herein. The DL entity shown in R1-072301 is reproduced herein as the table shown in FIG. 2. It can be noted that the finally specified signaling entity may have another form, and may include other fields such as a field to indicate if the transmission is distributed or localized.

The exemplary embodiments of this invention provide for a more efficient signaling of the RACH response. As can be seen in FIG. 3, the unnecessary fields (for the RACH response) of the “normal” DL signaling entity are not transmitted. For example, the HARQ information is not transmitted. The pre-coding information may or may not be transmitted, however the selected format is preferably used consistently.

It should be noted that, as compared to FIG. 2, the signaling of the MCS and TBS is made more efficient by providing for a reduced set of modulation/coding schemes, and the use of 0 bits or 1 bit to indicate the modulation. For example, one bit can be used to signal whether QPSK or 16-QAM is to be used.

Note that it may be determined in 3GPP that only one type of modulation is used for the RACH response. In this case then no bits are needed for indicating the modulation, as the type of modulation may be known from specification, and hence pre-programmed into the UE 10, or it may be broadcast from the eNB 12 using, for example, the dynamic BCH.

It is also within the scope of the exemplary embodiments to provide a reduced set of possible TBSs.

As can be seen in FIG. 3, for an exemplary 5 MHz bandwidth case, the improved RACH response includes the following fields. In addition to a common CRC field, another common field may be present if the allocation of the temporary CRNTI is optimized in such a way that the IDs (for the different UEs 10) are implicitly derived from a single ID. In addition to these one or two common fields (common for all UEs 10), there is a field per acknowledged preamble. All of these fields (both the common and preamble specific) are of fixed size, and specified in such a way that the number of payload bits needed for a certain number of combined responses can be calculated. As such, the TBS may be calculated by the UE 10 if the number of responses is known.

For this purpose there can be provided, for example, 1-3 bits to indicate how many RACH responses are sent in the PDSCH. These bits can occupy part of the TFUTBS field, where one additional bit (for example) may be used to specify the modulation type (e.g., QPSK or 16-QAM, as was noted above).

The RACH response may be tied to the number of allocated PRBs and the modulation type. Thus, and by example, three bits may indicate for each modulation type and number of PRB combinations a total of eight possible of RACH responses, and thus a total of eight possible TBSs.

Still referring to FIG. 3, the RACH response signaling entity in the L1/L2 sent by the eNB 12 may contain the following fields: resource allocation; TH/TBS and CRC masked with RA-RNTI. RA-RNTI is thus an identity that is used for directing the RACH response signaling entity to the UEs 10 that have transmitted on the RACH.

In general, the RACH response message is directed to only a certain group of user equipments, that is, to those that have transmitted their preamble in a certain RACH opportunity (there is a mapping between the RA-RNTI and the frequency and time resource of the preamble).

The RACH response signaling entity in the L1/L2 may also contain the additional pre-coding field. The RACH response signaling entity may also contain other fields that may yet be decided upon in 3GPP, such as a distributed transmission bit.

The TBS bits indicate how many RACH responses are signaled in the PDSCH. Since the number of bits used for each one of the responses is known from specification, the UE 10 thus has knowledge of the number of transmitted payload bits (including headers and CRC) and thus knows (implicitly) the effective transport block size. Depending on whether byte alignment is used, the actual transport block size may be slightly larger than the effective size. The transport block size, modulation and number of allocated PRBs define the rate matching used in the PDSCH.

The interpretation of the TBS bits may depend on the number of allocated PRBs and the modulation. For example, with one PRB allocation and assuming the use of QPSK modulation, a three bit wide TBS may indicate from one to eight responses, while with a two PRB allocation and QPSK modulation the TBS may indicate from 5 to 12 responses.

In general, the allocation of RACH response to one or several UEs 10 is done via PDCCH by using RA-RNTI. As in the case of the downlink shared channel signaling entity the payload depends on the bandwidth. The information content to signal the RACH response or RACH responses is bandwidth independent, however the resource allocation and possibly also CRC bit field depend on bandwidth. For RACH signaling no HARQ information is required, and the pre-coding information may be unnecessary, especially when assigning RACH responses to more than one UE 10. The signaling of MCS and TBS can also be accomplished more effectively by employing a reduced set of modulation schemes (e.g., only QPSK), and by using a reduced set of possible TBSs. As a non-limiting example, 1-3 bits may indicate to the UE 10 how many fixed sized RACH responses are included in PDSCH.

Signaling this information thus clearly requires fewer bits than normal MCS/TBS signaling, e.g., with one PRB and QPSK modulation, eight different rate matching options can be defined, while with two PRBs and QPSK modulation eight partly or totally different rate matching possibilities can be defined.

It can be appreciated that the signaling of the RACH response is made efficient, and the signaling of TBS is more efficient than the approaches proposed for general TBS signaling.

Note that while the exemplary embodiments of this invention have been described in the context of the RACH response they are not so limited, and may be used as well for other signaling purposes, such as for paging indicator signaling.

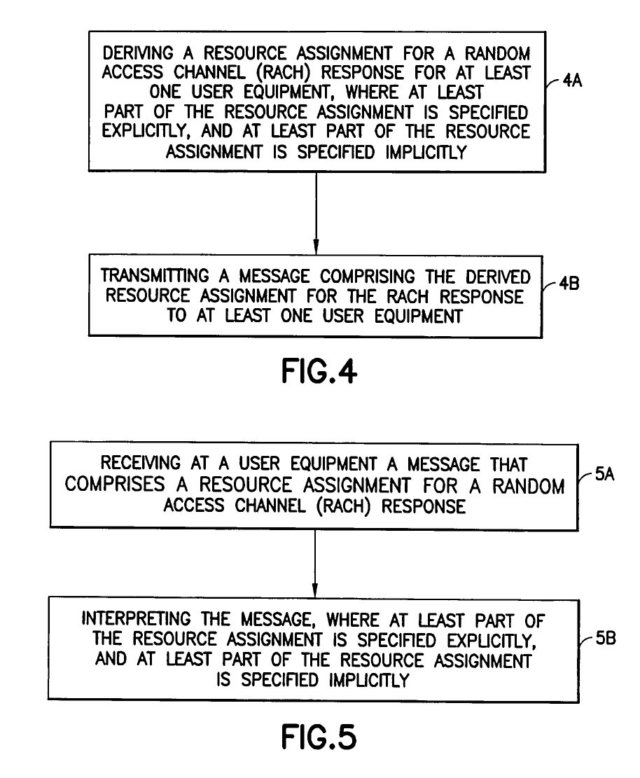

Referring to FIG. 4, based on the foregoing it should be apparent that the exemplary embodiments of this invention provide in one aspect thereof a method (Block 4A) to derive a resource assignment for a random access channel (RACH) response for at least one user equipment, where at least part of the resource assignment is specified explicitly, and at least part of the resource assignment is specified implicitly; and (Block 4B) to transmit a message comprising the derived resource assignment for the RACH response to at least one user equipment.

The method of the previous paragraph, where at least a transport block size is specified implicitly by specifying a number of RACH responses that are transmitted.

The method of the preceding paragraphs, where at least the transport block size is specified implicitly by specifying a number of RACH responses that are signaled in a physical downlink shared channel.

The method of the preceding paragraphs, where the message specifies a modulation coding scheme using no more than one bit.

Based on the foregoing it should be apparent that the exemplary embodiments of this invention provide in another aspect thereof a computer readable medium having recorded thereon program instructions that when executed perform operations of deriving a resource assignment for a random access channel (RACH) response for at least one user equipment, where at least part of the resource assignment is specified explicitly, and at least part of the resource assignment is specified implicitly; and transmitting a message comprising the derived resource assignment for the RACH response to at least one user equipment.

The computer readable medium of the previous paragraph, where at least a transport block size is specified implicitly by specifying a number of RACH responses that are transmitted.

The computer readable medium of the preceding paragraphs, where at least the transport block size is specified implicitly by specifying a number of RACH responses that are signaled in a physical downlink shared channel.

The computer readable medium of the preceding paragraphs, where the message specifies a modulation coding scheme using no more than one bit.

Based on the foregoing it should be apparent that the exemplary embodiments of this invention provide in another aspect thereof an apparatus that comprises a unit configured to derive a resource assignment for a random access channel (RACH) response for at least one user equipment, where at least part of the resource assignment is specified explicitly, and at least part of the resource assignment is specified implicitly; and a transmitter to transmit a message comprising the derived resource assignment for the RACH response to at least one user equipment.

The apparatus of the previous paragraph, where at least a transport block size is specified implicitly by specifying a number of RACH responses that are transmitted.

The apparatus of the preceding paragraphs, where at least the transport block size is specified implicitly by specifying a number of RACH responses that are signaled in a physical downlink shared channel.

The apparatus of the preceding paragraphs, where the message specifies a modulation coding scheme using no more than one bit.

It should be further appreciated that the exemplary embodiments of this invention provide in still further aspects thereof a user equipment, and method, and computer readable medium, as shown in FIG. 5, that is configured to (Block 5A) receive a message that comprises a resource assignment for a random access channel (RACH) response, and (Block 5B) to interpret the message wherein at least part of the resource assignment is specified explicitly, and at least part of the resource assignment is specified implicitly to the user equipment.

The user equipment, and method, and computer readable medium of the previous paragraph, where at least a transport block size is specified implicitly by specifying a number of RACH responses that are transmitted.

The user equipment, and method, and computer readable medium of the preceding paragraphs, where at least the transport block size is specified implicitly by specifying a number of RACH responses that are signaled in a physical downlink shared channel.

The user equipment, and method, and computer readable medium of the preceding paragraphs, where the message specifies a modulation coding scheme using no more than one bit.

Note that the various blocks shown in FIGS. 4 and 5 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. As such, it should be appreciated that at least some aspects of the exemplary embodiments of the inventions may be practiced in various components such as integrated circuit chips and modules.

Various modifications and adaptations to the foregoing exemplary embodiments of this invention may become apparent to those skilled in the relevant arts in view of the foregoing description, when read in conjunction with the accompanying drawings.

However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems.

Further, the various names assigned to different channels, messages and information elements (e.g., RACH, PDSCH, TFI, TBS, etc.) are not intended to be limiting in any respect, as these various channels, messages and information elements may be identified by any suitable names.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
receiving a message that comprises a resource assignment for a random access channel response; and
interpreting the received message, wherein at least part of the resource assignment is specified explicitly, and at least part of the resource assignment is specified implicitly.

2. The method of claim 1, wherein at least a transport block size is specified implicitly by a number of random access channel responses that are received from a base station.

3. The method of claim 1, wherein at least a transport block size is specified implicitly by a number of random access channel responses that are signaled by a base station in a physical downlink shared channel.

4. The method of claim 1, wherein the message specifies a modulation coding scheme using no more than one bit.

5-34. (canceled)

35. The method of claim 1, wherein the message comprises a resource allocation field, a transport format indicator/transport block size field, and a cyclic redundancy code field masked with a random access radio network temporary identifier used to direct the random access channel response message to only a certain group of user equipments.

36. A memory medium that stores computer program instructions, the execution of which result in operations that comprise:
receiving a message that comprises a resource assignment for a random access channel response; and
interpreting the received message, wherein at least part of the resource assignment is specified explicitly, and at least part of the resource assignment is specified implicitly.

37. The memory medium of claim 36, wherein at least a transport block size is specified implicitly by a number of random access channel responses that are received from a base station.

38. The memory medium of claim 36, wherein at least a transport block size is specified implicitly by a number of random access channel responses that are signaled by a base station in a physical downlink shared channel.

39. The memory medium of claim 36, wherein the message specifies a modulation coding scheme using no more than one bit.

40. The memory medium of claim 36, wherein the message comprises a resource allocation field, a transport format indicator/transport block size field, and a cyclic redundancy code field masked with a random access radio network temporary identifier used to direct the random access channel response message to only certain user equipment.

41. An apparatus, comprising:
a radio frequency receiver; and
a controller configured to interpret a received message that comprises a resource assignment for a random access channel response, wherein at least part of the resource assignment is specified explicitly, and at least part of the resource assignment is specified implicitly.

42. The apparatus of claim 41, wherein at least a transport block size is specified implicitly by a number of random access channel responses that are received from a base station.

43. The apparatus of claim 41, wherein at least a transport block size is specified implicitly a number of random access channel responses that are signaled in a physical downlink shared channel by a base station.

44. The apparatus of claim 41, wherein the message specifies a modulation coding scheme using no more than one bit.

45. The apparatus of claim 41, wherein the message comprises a resource allocation field, a transport format indicator/transport block size field, and a cyclic redundancy code field masked with a random access radio network temporary identifier used to direct the random access channel response message to only a certain group of user equipments.

46. The apparatus of claim 41, embodied in at least one integrated circuit.

47. An apparatus, comprising:
a radio frequency transmitter; and
a controller configured to derive a resource assignment for a random access channel response for at least one user equipment, wherein at least part of the resource assignment is specified explicitly and at least part of the resource assignment is specified implicitly; said radio frequency transmitter being further configured to transmit a message comprising the derived resource assignment for the random access channel response to at least one user equipment.

48. The apparatus of claim 47, wherein at least a transport block size is specified implicitly by specifying a number of random access channel responses that are transmitted.

49. The apparatus of claim 47, wherein at least a transport block size is specified implicitly by specifying a number of random access channel responses that are signaled in a physical downlink shared channel.

50. The apparatus of claim 47, wherein the message specifies a modulation coding scheme using no more than one bit.
